(19) United States
(12) Patent Application Publication
(10) Pub. No.: US 2021/0042789 A1
(43) Pub. Date: Feb. 11, 2021

(54) METHODS AND SYSTEMS FOR PROVIDING AN ELECTRONIC WALLET FOR MANAGING TRANSACTION-BASED TARGETED MEDIA

(71) Applicant: Konnect Mobile Communications Inc., Montreal (CA)

(72) Inventor: William Lee COYLE, Montreal (CA)

(73) Assignee: Konnect Mobile Communications Inc., Montreal, QC (CA)

(21) Appl. No.: 16/767,283

(22) PCT Filed: Nov. 28, 2017
(86) PCT No.: PCT/CA2017/000254

§ 371 Date: May 27, 2020

(51) Int. Cl. G06Q 30/02; G06Q 20/10; G06Q 20/08; G06Q 20/36

(52) U.S. Cl. CPC G06Q 30/0258; G06Q 30/0236; G06Q 20/3678; G06Q 20/0855; G06Q 20/108

(57) ABSTRACT

In at least one embodiment, the present invention provides a systems and methods for executing an electronic commercial transaction between an electronically authenticated first and electronically authenticated second user device both in electronic communication with an electronic communication network and a central distribution server, the first user device having access to a first user account, receiving transaction information from the first user device, sending the transaction information to a second user device having access to a second user account, sending a query, retrieving a query response from at least one of the first user device and the second user device, displaying an advertisement based on the result of the query, receiving transaction confirmation information, and electronically transferring funds from one account to another account.

### FIELD

The present invention relates to methods and systems for facilitating electronic commerce transactions using an electronic wallet hosted on a mobile device. More specifically, the present invention relates to methods and systems for managing the distribution of digital and mobile targeted media through a network-connected device in response to an electronic commerce transaction conducted using an electronic wallet hosted on the mobile device.

### BACKGROUND

Electronic commercial transactions have slowly supplanted cash transactions in both online and traditional “brick and mortar” commercial establishments for a variety of reasons. When a commercial transaction can be conducted electronically, the customer no longer is required to have sufficient funds on hand in the form of cash and the vendor is not required to store and maintain sufficient cash on hand to facilitate the transaction.

In the context of online transactions over the internet, electronic commercial transactions permit the vendor and the customer (or, for example, a transferor and a transferee) to be physically separated by significant distance. It will also be readily understood that a cash transaction is typically limited to single currency (or a preselected group of currencies) while an electronic transaction can theoretically be currency agnostic. Moreover, there are significant costs to the production, issuance, maintenance, transfer and storage of physical currency.

Accordingly, a number of solutions have been developed to fulfill the clear advantages that electronic commercial transactions offer participants in the modern global economy. For example, credit cards have been available for some time, which offer the ease of a cashless transaction with the outstanding balance settled between the credit card owner and the credit card issuing companies at a future date. In turn, credit card issuing companies generally charge the vendor a fee for renting/purchasing a point-of-sale (“POS”) terminal and a fee for processing the transaction, while the customer is charged interest on any outstanding balances and potentially an annual fee for use of the credit card. As such there are significant user costs associated with using a credit card in a transaction.

Electronic debit transaction systems have been developed where a customer employs an electronic access card to securely access a bank account directly through a POS terminal in a similarly cashless fashion. In this way, the funds for an electronic commercial transaction can be “debited” directly from the user's account. However, in this arrangement the vendor typically pays a rental/purchase fee for the POS terminal (to a bank or other third-party) and the user pays a transaction fee, typically collected by the bank where the account is registered.

Mobile payment systems have been developed wherein the customer can use a mobile phone as an electronic wallet in connection with a POS terminal in order to eliminate the need for an electronic access or credit card and thereby streamlining the transaction process from a user's perspective. However, from the perspective of a vendor, credit card company or a financial institution, the process remains largely the same as the traditional solutions with fees charged for interest, account access, and POS terminal purchase/rental as appropriate.

Moreover, there is currently no manner in which a customer can be targeted with targeted media at a time proximate to when an electronic commercial transaction is completed with an electronic wallet. As will be readily appreciated, a customer who has recently completed a transaction using an electronic wallet could arguably be a satisfied customer that would not only be receptive to targeted media but may in fact be willing to participate in another transaction or promotion.

Accordingly, there is need for an electronic commercial transaction system that can be completed using an electronic wallet, is currency and denomination agnostic, does not require a dedicated POS terminal, can reduce or eliminate the fees associated with the transaction and which permits targeting a customer with targeted media at a time proximate to when an electronic commercial transaction is completed.

### SUMMARY

It is contemplated that the present invention can provide an electronic commercial transaction system that can be completed using an electronic wallet, is currency and denomination agnostic, does not require a dedicated POS terminal, can reduce or eliminate the fees associated with the transaction and which permits targeting a customer with targeted media at a time proximate to when an electronic commercial transaction is completed.

In at least one embodiment, the present invention provides a method for executing an electronic commercial transaction comprising the steps of authenticating a first user device with a central distribution server, the first user device having electronic access to a first user account and in electronic communication with an electronic communication network, the central distribution server in electronic communication with the electronic communication network, receiving transaction information from the first user device, sending the transaction information to a second user device having electronic access to a second user account and in electronic communication with the electronic communication network, authenticating the second user device with the central distribution server, receiving transaction confirmation information from the second user device at the central distribution server, sending a query to at least one of the first user device and the second user device, retrieving a query response from at least one of the first user device and the second user device, if the query response indicates that targeted media will not be displayed, retrieving transaction execution information from at least one of the first user device and the second user device, and electronically transferring funds from one of the first user account and the second user account to at least one of the other of the first user account and the second user account and a central distribution server account, and if the query response indicates that targeted media will be displayed retrieving the targeted media from the central distribution server, sending the advertisement to at least one of the first user device and the second user device, displaying the advertisement on at least one of the first user device and the second user device, and upon completion of displaying the targeted media, retrieving transaction execution information from at least one of the first user device and the second user device, and electronically transferring funds from one of the first user account and the second user account to at least one of the other of the first user account and the second user account and a central distribution server account.

In at least one embodiment, the present invention provides a system for executing an electronic commercial transaction, the system comprising at least a first user device having electronic access to a first user account and in electronic communication with an electronic communication network, at least a second user device having electronic access to a second user account and in electronic communication with an electronic communication network, and a central distribution server having electronic access to a central distribution server account and in electronic communication with an electronic communication network, wherein the first user is authenticated electronically with the central distribution server and transaction information is received from the first user device over the electronic communication network, transaction information is sent electronically from the first user device to the second user device over the electronic communication network, the second user device is authenticated electronically with the central distribution server and transaction confirmation information is received from the second user device by the central distribution server, a query is sent from the central distribution server to at least one of the first user device and the second user device, and a query response is retrieved from at least one of the first user device and the second user device and sent to the central distribution server, if the query response indicates that targeted media will not be displayed, transaction execution information is retrieved from at least one of the first user device and the second user device, and funds are electronically transferred from one of the first user account and the second user account to at least one of the other of the first user account and the second user account and the central distribution server account, and, if the query response indicates that targeted media will be displayed, targeted media is retrieved from the central distribution server, the targeted media is sent to at least one of the first user device and the second user device, the targeted media is displayed on at least one of the first user device and the second user device, transaction execution information is retrieved from at least one of the first user device and the second user device, and funds are electronically transferred from one of the first user account and the second user account to at least one of the other of the first user account and the second user account and the central distribution server account.

### BRIEF DESCRIPTION OF THE FIGURES

The present invention will be better understood in connection with the following Figures, in which:

FIG. 1 is a diagram of a system for performing the present method in accordance with at least one embodiment of the present invention;

FIG. 2 is a diagram of a method in accordance with at least one embodiment of the present invention;

FIG. 3 is a diagram of a method in accordance with another embodiment of the present invention; and

FIG. 4 is a diagram of a method in accordance with another embodiment of the present invention.

### DETAILED DESCRIPTION OF THE EMBODIMENTS

It is contemplated that the present invention can provide an electronic commercial transaction system that can be completed using an electronic wallet, is currency and denomination agnostic, does not require a dedicated POS terminal, can reduce or eliminate the fees associated with the transaction and which permits targeting a customer with targeted media at a time proximate to when an electronic commercial transaction is completed.

In at least one embodiment the present invention provides a method and system having at least a first and second user device in electronic communication with one another over an electronic communication network and in electronic communication with a central distribution server. It is contemplated that the present invention can be executed by way of enterprise software that is run as web-based software-as-a-service through the central distribution server, through mobile software applications loaded on mobile devices and as enterprise software within an organization among any other types of software arrangements or hybrid software arrangements that will be readily appreciated by the skilled person.

In the context of the present invention, it is contemplated that a suitable user device can be any suitable computing device having data input capability, electronic communication network connectivity and support for the execution of an electronic commercial transaction as discussed herein. In at least one embodiment, it is contemplated that a suitable mobile device will be adapted to run software in order to function as an electronic wallet.

For example, a suitable user device could include, but is not limited to, a mobile device such as a smartphone, a desktop computer terminal, a tablet computer, a laptop, a wearable device and a point-of-sale device, among any other suitable user devices adapted to run software in order to function as an electronic wallet that will be readily understood by the skilled person.

As will be readily understood by the skilled person, in the context of the present invention an electronic wallet is contemplated as suitable software running on a suitable user device that permits a user to complete an electronic commercial transaction and which provides access to the user's identification information, authentication credentials, account details and history and any other required transaction information so that such information can be electronically transferred from a first user device to a second user device (and vice versa) in order to facilitate the completion of an electronic commerce transaction.

As will be readily appreciated by the skilled person, a suitable mobile device can have, but is not limited to, input means (in the form of, for example, a touchscreen, microphone, or keyboard) wireless or hardwired connectivity (in the form of, for example, a network interface controller, a wireless network interface controller, a broadband modem, or a radio transceiver), a power source, temporary, permanent and read-write data storage and media playback capability on output means (in the form of, for example, a speaker or video screen).

Moreover, in the present context a suitable electronic communication network in accordance with the present invention is a network that permits electronic communication between suitably connected user devices. Suitable electronic communication networks could be a global wireless and hardwired network such as the internet, an internal hard-wired local area network with an institution or a private network of wirelessly connected user devices, among a wide variety of other arrangements that will be readily appreciated by the skilled person. It is contemplated that electronic communication over the network can enable secure or insecure and encrypted or unencrypted electronic communications, depending on the needs of the particular end user application.

In the context of the present invention, a suitable central distribution server will be a computing device having electronic communication network connectivity and electronic access to physical data storage. It is contemplated that the central distribution server could be one or a number of suitable servers, and can be located in a single or multiple locations, suitably connected to the user device through the electronic communication network.

It is contemplated that each user device has electronic access to an associated user account. In the context of the present invention, a suitable user account can take a variety of forms depending on the needs of the particular end user application. For example, in one embodiment the user account is a client account associated with the central distribution server that the user accesses through a mobile software application or application program interface. In others, the user account may in fact be an electronic account that the user accesses through a mobile software application or application program interface that is placed with a third-party institution, among other arrangements that will be readily understood by the skilled person.

It is contemplated that the user account can be a client account, an enterprise account, a third-party financial institution account, a pre-loaded cash account and a non-currency rewards account, among any other types of accounts that will be readily appreciated by the skilled person. The account can be comprised or any currency or currencies, denominations and can be comprised of monetary amounts or non-monetary amounts (such as rewards or loyalty points) as will be readily understood by the skilled person. It is contemplated that the user device has secure and encrypted communication with the associated user account however in some embodiments it is contemplated that such protections are not required, depending on the needs of the end user application.

In some embodiments, it is contemplated that the user accesses an account through a mobile software application running on the user device while in other embodiments the user accesses an account through an application program interface with a third-party institution, among other arrangements that will be readily appreciated by the skilled person.

It is contemplated that the present invention provides a method and system for executing an electronic commercial transaction between the user devices. In the context of the present invention, a suitable electronic commercial transaction can take a number of forms including, but not limited to, an electronic fund transfer from a first user to second user, an electronic payment of funds for a purchase executed between a vendor and a customer, an electronic payment of a bill between a customer and an institution, a withdrawal or deposit of funds from a financial institution and a user, an automated teller machine (ATM) withdrawal or deposit, and a multi-party electronic commercial transaction, among any other type of suitable electronic transaction between at least two parties that will be readily understood by the skilled person.

In some embodiments it is contemplated that a suitable electronic commercial transaction between a first user's electronic wallet and a second user's electronic wallet, between a user's electronic wallet and a point-of sale device, or between a user's electronic wallet and an electronic commerce web portal, among other suitable electronic commercial transactions as required by the particular end-user application of the present invention.

It is further contemplated that an electronic transaction can be between a first consumer user and a second consumer user (C2C), between a consumer user and a business (B2C) or between a first business and a second business (B2B), among other suitable electronic commercial transactions as required by the particular end user application of the present invention.

In some embodiments, it is contemplated that an electronic commercial transaction can be executed wireless between remotely located user devices over an electronic communication network, or alternatively can be executed directly between user devices that are in near field communication, among other arrangements that will be readily appreciated by the skilled person.

In at least one embodiment it is contemplated that user devices can communicate electronically in close proximity by way of scanning an electronic code (such as, but not limited to, a UPC, QR or customized code) that contains encoded information necessary for facilitating the transaction.

It is further contemplated that electronic commercial transactions can take place through a variety of electronic communication network formats. For example, an electronic commercial transaction can take place through SMS, device to device near field communication, wireless application protocol, through the internet and within a mobile application environment (including but not limited to Android®, Apple® and Blackberry® applications), among any other suitable electronic communication network format as will be readily appreciated by the skilled person.

In at least one embodiment, it is contemplated that the first user device (i.e. the user device that initiates the electronic transaction) is authenticated with the central distribution server. In some embodiments, authentication can occur between the user device and the central distribution server, while in other embodiments the authentication can be performed completely by a single device, or by two or more devices in electronic communication with one another, among other arrangements that will be readily appreciated by the skilled person.

In the context of the present invention, authentication of a user device can take a variety of forms. In at least one embodiment, authentication can involve cross-referencing input authentication information provided by the user of the mobile device with reference authentication information stored on the central distribution server in connection with the corresponding user account. It is contemplated that authentication information can include but is not limited to a password or other alphanumeric string, personal information, a fingerprint, a facial photograph, a skill-testing question and contextual question, among any other type of authentication information that will be readily understood by the skilled person. It is also contemplated that a user device may be authenticated initially and remain in a constantly authenticated state that is detected by the central distribution server as discussed in further detail below.

Once the first (or initiating) user device is authenticated, transaction information can be sent to a second user device. It is contemplated that the transaction information can be generated before or after the first user device has been authenticated. Moreover, it is contemplated that transaction information may include, but is not limited to, transaction type (i.e.: transfer, purchase, service payment) transaction amount, transaction party identities, transaction currency, transaction party geographic location, transaction details (such as, but not limited to, unit quantities, product serial numbers, invoice numbers) among any other type of transaction information that could be required to execute the transaction between the parties.

Once the transaction information is generated it is sent to the second user device which must also be authenticated. It is contemplated that the first and second user devices can remain in a constantly authenticated state that is detected by the central distribution server or alternatively in other embodiments the first and second user device are authenticated each time a transaction is initiated between the first user device and the second user device. It is contemplated that the second user device is authenticated in an analogous manner as the first user device as discussed herein.

In some embodiments it is contemplated that the transaction information is sent through the central distribution server and in other embodiments it is contemplated that the transaction information is sent directly between the first device and the second device.

Once the first device and the second user devices are both authenticated and the transaction information has been passed from the first (or initiating) user device to the second user device, it is contemplated that in turn the second user device can in turn send transaction confirmation information to at least one of the central distribution server and the first (or initiating) user device.

It is contemplated that transaction confirmation information can take a variety of forms and in the simplest embodiments will simply include a transaction confirmation to the central distribution server or the initiating user device, however other types of transaction confirmation information is contemplated including but not limited to authentication status, user account information, updated user information or user device geographic location, a custom generated code (such as, but not limited to, an alphanumeric string or a visual QR code or barcode) among any other type of transaction confirmation information that may be required by the particular end user application under consideration.

Once the transaction confirmation information is received from the second user device by the central distribution server, the transaction can be executed. Depending on the nature of the transaction, a query is sent to at least one of the first user device and the second user device. As will be understood by the skilled person, in some transactions (such as money transfers), the query may be sent to the first (or initiating device) while in other transactions (such as purchases) the query will be sent to the second user device. In some transactions, it is contemplated that both user devices may receive a query.

In some embodiments, it is contemplated that the query can be sent along with the transaction information (as discussed herein) depending on the particular type of transaction that is contemplated by the particular end user application of the present invention. In this way, the user device can receive the query at the time it receives the transaction information, however other arrangements are also contemplated wherein the transaction information is sent separately from the query.

It is contemplated that the query can take a variety of forms. In at least one embodiment is it is contemplated that the query is: “View Advertisement?” although other arrangements are also contemplated. For example, it is contemplated that the query includes the opportunity for the user to determine whether he/she would prefer to view an advertisement or pay a transaction fee in order to complete the electronic commercial transaction. In other embodiments, the user may be invited to participate in a survey or to provide information. As such, there are any number of ways the query can be presented and the appropriate query response can be framed in order to determine the user's choice in the matter.

Moreover, it is contemplated that the user can be queried every time a transaction is proposed/executed or alternatively the user may only be queried once (or occasionally) in order to determine if the user would prefer to view an advertisement or pay a transaction fee in order to complete the electronic commercial transaction fee.

Once the query is received by at least one of the first and second user device it is contemplated that a query response can be generated by the user device. In at least one embodiment, it is contemplated that the query response can be selected from a pre-determined group of query responses depending on the nature of the query. In these embodiments, it is contemplated that the predetermined query response can be positive or negative, although other types of query responses are also contemplated.

It is contemplated that the query is provided to a transacting user in order to determine whether that user is interested in viewing targeted media and thereby reducing (or eliminating) an additional transaction fee that can be payable by that user in order to completed the electronic commercial transaction by transferring funds between the first user account and the second user account, or alternatively decline to view targeted media and thereby incur an additional transaction fee in order to completed the electronic commercial transaction by transferring funds between the first user account and the second user account.

In at least one embodiment, if the query is “View Advertisement?” and the query response is positive, it is contemplated that an advertisement may be retrieved from a preselected group of advertisements stored on the central distribution server and sent to the user device. In these embodiments it is contemplated that the advertisement may be automatically displayed on the user device in question.

Alternatively, it is contemplated that the query is “Pay fee?” and the query response is negative, it is contemplated that an advertisement may be retrieved from the central distribution server and sent to the user device. In these embodiments it is contemplated that the advertisement may be automatically displayed on the user device in question.

In the context of the present invention, suitable targeted media can take a variety of forms. For example, targeted media can include but is not limited to an advertisement (including a video advertisement, audio advertisement or a visual advertisement), a survey, a skill-testing question and a prompt to input information, among any other type of suitable targeted media that requires some type of engaged involvement from the user. Suitable targeted media may be interactive in that it requires the user's input or alternatively may be non-interactive.

Moreover, it is contemplated that the targeted media may be automatically selected from a preselected group of targeted media stored on the central distribution server for display on a user device based on at least one pre-established factor. For example, the pre-established factor could be the frequency that the target media has been viewed, the number of times the target media has been previously viewed, the identity of either the first or the second user, the geographic location of the first or the second user, the novelty of the target media (i.e.: whether the target media has been displayed before), the type of transaction that the users are engaging in and the user's prior behavior, among any other suitable pre-established factor that will be readily understood by the skilled person.

In some embodiments, once the targeted media is displayed on the user device for a predetermined time, electronic funds can be transferred between the first user account and the second user account through the electronic communication network in order to complete the transaction. In at least one embodiment it is contemplated that the targeted media must be displayed until completion for the transfer of funds to occur, which can be previously determined.

In some embodiments, if the query is “View Advertisement?” and the query response is negative, it is contemplated that additional electronic transaction information may be retrieved from the user device in question in order to augment electronic transaction information that is compiled in order to complete the electronic transaction.

In other words, in some embodiments it is contemplated that if the user chooses not to view the targeted media on the user device than an additional transaction fee can be charged (or in other embodiments, a discount can be applied) and therefore the details of the underlying, initial electronic transaction need to be augmented in order to complete the overall electronic transaction including this additional (or discounted) transaction fee. In at least one embodiment, it is contemplated that the additional transaction fee can be payable to the third party operating the central distribution server, however other arrangements are also contemplated.

Once the query response is received and the targeted media is either displayed or bypassed depending on the content of the query response, the transaction can in turn be executed. Depending on the nature of the transaction, transaction execution information is sent to at least one of the first user device and the second user device. As will be understood by the skilled person, in some transactions (such as money transfers), the transaction execution information may be sent to the first (or initiating device) while in other transactions (such as purchases) the transaction execution information will be sent to the second user device. In some transactions, both user devices may receive transaction execution information.

Once the electronic transaction information is completed (and augmented if required), in some embodiments it is contemplated that electronic funds are transferred between the first user account and the second user account through the electronic communication network in order to complete the electronic commercial transaction. In some embodiments, it is contemplated that electronic funds are transferred only between the first user account and the second user account while in other embodiments it is contemplated that funds can be transferred from the first user account (or the second user account) to the second user account (or the first user account) and, additionally, to a central distribution server account, depending on the particular arrangement of the end user application. In this way, a transaction fee can be transferred to the central distribution server account that is separate from the funds that are to be transferred between the user devices.

As will be readily understood by the skilled person it is contemplated that in an electronic commercial transaction between two parties, electronic funds can be transferred in either direction depending on the nature of the transaction and moreover either (or even both) entities can be charged with an additional transaction fee (if, the query response is negative and targeted media is not displayed) depending on the specifics of the particular end user application.

Moreover, in some embodiments, an additional call-to-action may be presented to the user after the targeted media has been displayed on the user device. For example, once the targeted media has been displayed, it is contemplated that the user may be presented with the following call-to-action options: Buy it now, display later and discard advertisement, however any number of other call-to-action options are contemplated for use in connection with the present invention.

In this way, as will be readily understood by the skilled person, the present invention provides a method and system for enabling an electronic commerce transaction with a user device that is adapted to function as an electronic wallet, wherein the transacting user has the opportunity to either view targeted media or pay an additional fee when completing an electronic transaction with another user. In this way, the transacting user can be “targeted” with targeted media at a time that is proximate to the completion of an electronic commercial transaction. In this way, the targeted media is displayed to the user in a moment when the user's attention is captive.

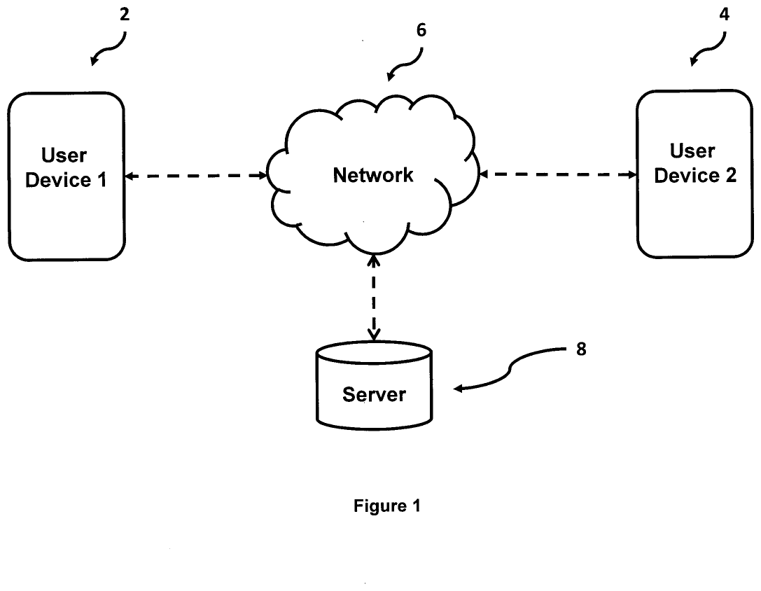

Turning to FIG. 1, at least one embodiment of a system for use in connection with the present invention is illustrated. In this embodiment, a first user device 2 is in wireless electronic communication with a second user device 4 through an electronic communication network 6. In this embodiment, user devices 2, 4 are mobile smartphone devices that are adapted to function as an electronic wallet and electronic communication network 6 is a wireless mobile communication network.

In this embodiment, user devices 2, 4 are also in wireless electronic communication with a central distribution server 8 through electronic communication network 6.

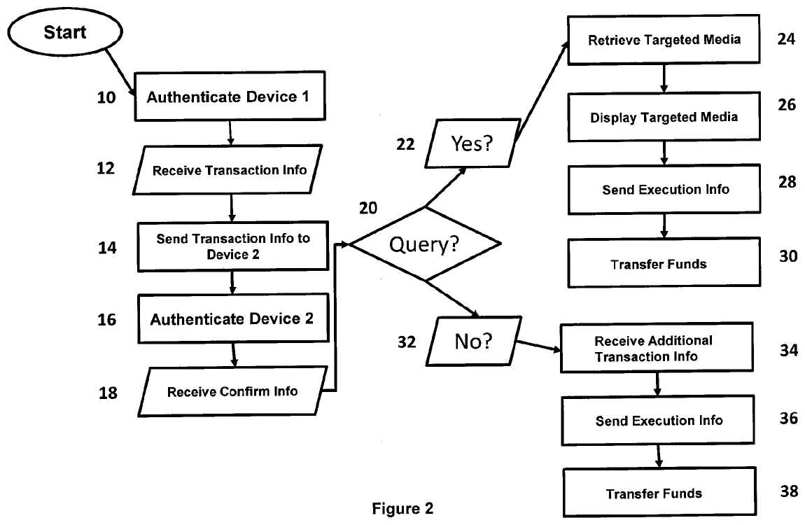

Turning to FIG. 2, at least one embodiment of a method for use in connection with the present invention is illustrated. In this embodiment, the method starts with authentication of a first user device 10.

In this embodiment, it is contemplated that the authentication step is performed between the first user device and a central distribution server. As stated previously herein, it is also contemplated that this authentication step can include the central distribution server detecting that the user device is in a constantly authenticated state or a previously authenticated state.

Next, it is contemplated that transaction information is generated by the first user device and received by either a second user device or the central distribution server 12. As will be readily understood by the skilled person, in instances where the first and second user devices are in direct communication with one another (by, for example, near field communication or through scanning a custom-generated barcode) the transaction information is received directly by the second user device, while in other embodiments it is contemplated that the transaction information can be received by the central distribution server by way of the electronic communication network and automatically routed to the second user device through the electronic communication network. In some embodiments it is contemplated that transaction information is received both directly from the second user device and from the central distribution server through the electronic communication network.

In this embodiment the transaction information is received from the first user device 12 and in turn sent to the second user device 14. In this embodiment, the second user device is authenticated with the central distribution server 16 upon receiving the transaction information from the first user device, however, in other embodiments it is contemplated that the second user device is previously authenticated or authenticated on a recurring basis.

Next, transaction confirmation information is received from the second user device 18 through the electronic communication network. In this embodiment, the transaction confirmation information is received from the second user device 18 and sent to the central distribution server through the electronic communication network, however in other embodiments it is contemplated that the transaction confirmation information is received from the second user device 18 and sent to the first user device.

Next, once the appropriate transaction confirmation is received 18, a query is sent to at least one of the first user device and the second user device 20 from the central distribution server through the electronic communication network. As will be understood by the skilled person, the nature of the transaction will dictate where the query will be sent to. For example, if the transaction is an electronic money transfer, the query can be sent to the first user device and if the transaction is a payment for goods at a bricks-and-mortar commercial establishment, the query can be sent to the second user device.

It is contemplated that query 20 can take a variety of forms, however in the context of the present invention it is contemplated that query 20 includes the opportunity to provide a query response that indicates whether targeted media is to be displayed 22 (in this embodiment, a positive response) or whether targeted media is not to be displayed 32 (in this embodiment, a negative response). As will be readily appreciated by the skilled person, the query and associated query response can take a near limitless variety of forms provided that is possible to indicate whether targeted media will be displayed on at least one of the first and second user devices or alternatively whether an additional transaction fee will be charged to at least one of the first and second user devices.

If the query response received from at least one of the first and second user devices indicates that targeted media is to be displayed 22, suitable targeted media is automatically retrieved by the central distribution server from a preselected group of targeted media stored with the central distribution server 24. As discussed herein, it is contemplated that the targeted media can be selected from the preselected group of targeted media based on any number of factors, including, the first device user identity, the second device user identity, the transaction type, the geographic location of either the first or second user device and the advertisement display frequency, among any other number of suitable factors that will be readily appreciated by the skilled person.

Once suitable targeted media is automatically retrieved by the central distribution server, it is forwarded by the central distribution server through the electronic communication network to the appropriate user device which provided the query response and the retrieved targeted media can be displayed on that user device 26. As discussed previously, it is contemplated that the user device has the capability to display a number of suitable targeted media, including but not limited to a video advertisement, image-based advertisement, an audio advertisement and a survey.

Once the targeted media has been displayed on the appropriate user device 26, it is contemplated that the transaction can be completed and transaction execution information can be sent from the second user device to the first user device and/or the central distribution server and funds can be transferred automatically and electronically by the central distribution server between the user account associated with the first user device and the user account associated with the second user device 30. As discussed herein, it is contemplated that the user accounts can be stored, managed and accessed electronically with the central distribution server or alternatively with the local storage available in connection with each user device, among other arrangements that will be readily understood by the skilled person, including an account managed by a third-party institution that is accessed by way of an application program interface that is executed by either the central distribution server or the associated user device as required by the particular end-user application.

On the other hand, if the query response received from at least one of the first and second user devices indicates that targeted media is not to be displayed 32, transaction execution information will be updated with additional transaction information that is received from the appropriate user device that provides the query response 34. In this way, the transaction can be updated with an additional transaction fee (or, alternatively a discounted transaction fee) that can be payable to a user account or an enterprise account associated with the central distribution server as required by the particular end user application of the present invention.

Next, it is contemplated that the transaction can be completed and funds can be transferred automatically and electronically by the central distribution server between the user account associated with the first user device and the user account associated with the second user device 38. As discussed herein, it is contemplated that the transaction fee can be paid by the first user, the second user or both users depending on the nature of the transaction that is being executed.

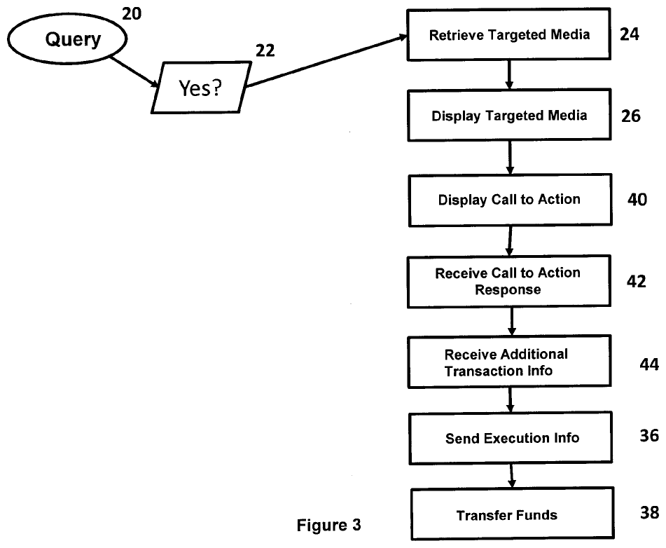

Turning to FIG. 3, in some embodiments it is contemplated that after a query response is received from at least one of the first and second user devices that indicates that targeted media is to be displayed 22 and the targeted media is retrieved from a preselected group of targeted media 24, displayed on the user device 26 and an additional call-to-action is displayed 40. If the call-to-action requires an additional purchase or any suitable augmentation of the transaction information, it is contemplated that a call-to-action response is received from the user device 42 and additional transaction information is received from the appropriate user device 44 and the transaction is executed by the sending of augmented transaction execution information between the first user device and the second user device through the central distribution server over the electronic communication network 36 and the subsequent transfer of funds between the user account associated with the first user device and the user account associated with the second user device 38 through the central distribution server over the electronic communication network.

As discussed herein, the call-to-action can take a variety of forms including a “Buy Now” call-to-action that executes an additional transaction, a “Show Me Later” call-to-action that automatically schedules additional display of the targeted media at a later date, and a “Don't Show Me Again” call-to-action that removes the targeted media from the preselected group of targeted media stored on the central distribution server associated with that particular user account, among any other type of call-to-action that may be contemplated by the skilled person.

For example in some embodiments if the call-to-action response that is received 42 is a “Buy Now” call-to-action and the users selects to authorizes an additional transaction, it is contemplated that additional transaction information is received from the appropriate user device 44 and the transaction is executed by the sending of this augmented transaction execution information between the first user device and the second user device through the central distribution server over the electronic communication network 36 and the subsequent transfer of funds between the user account associated with the first user device and the user account associated with the second user device 38 through the central distribution server over the electronic communication network.

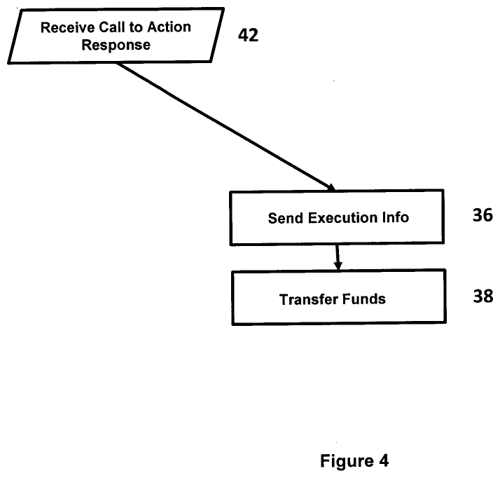

For example and with reference to FIG. 4, in embodiment if the call-to-action response that is received 42 is that the user selects not to authorize an additional transaction, it is contemplated that additional transaction information is not required and the transaction is executed by the sending of transaction execution information between the first user device and the second user device through the central distribution server over the electronic communication network 36 and the subsequent transfer of funds between the user account associated with the first user device and the user account associated with the second user device 38 through the central distribution server over the electronic communication network.

In this way, it is contemplated that the present invention provides systems and methods for executing an electronic commercial transaction between user devices and targeting at least one of the user devices with targeted media at a time proximate to when an electronic commercial transaction is completed with a user device that is adapted to be used as an electronic wallet. Should the user of the targeted user device decide not to view the targeted media, an additional transaction fee can be automatically transferred from the user account associated with the particular user device.

Moreover, it is further contemplated that an additional call-to-action can be displayed to a user who views targeted media at a time proximate to when an electronic commercial transaction is completed. In this way, an additional targeted electronic transaction can be completed based on the results of targeted media displayed to a user at a time proximate to when an electronic commercial transaction is completed with a user device that is adapted to be used as an electronic wallet.

While the present invention has been described with reference to two particular embodiments it will be apparent to anyone skilled in the art that there are many permutations and combinations of combining the primary response variables to achieve particular benefits. All such permutations and combinations are considered to be within the sphere and scope of this invention as defined in the claims appended hereto.

1. A method for executing an electronic commercial transaction comprising the steps of:
authenticating a first user device with a central distribution server, the first user device having electronic access to a first user account and in electronic communication with an electronic communication network, the central distribution server in electronic communication with the electronic communication network;
receiving transaction information from the first user device;
sending the transaction information to a second user device having electronic access to a second user account and in electronic communication with the electronic communication network;
authenticating the second user device with the central distribution server,
receiving transaction confirmation information from the second user device at the central distribution server;
sending a query to at least one of the first user device and the second user device,
retrieving a query response from at least one of the first user device and the second user device;
if the query response indicates that targeted media will not be displayed:
retrieving transaction execution information from at least one of the first user device and the second user device; and
electronically transferring funds from one of the first user account and the second user account to at least one of the other of the first user account and the second user account and a central distribution server account; and
if the query response indicates that targeted media will be displayed:
retrieving the targeted media from the central distribution server;
sending the advertisement to at least one of the first user device and the second user device;
displaying the advertisement on at least one of the first user device and the second user device; and
upon completion of displaying the targeted media, retrieving transaction execution information from at least one of the first user device and the second user device; and
electronically transferring funds from one of the first user account and the second user account to at least one of the other of the first user account and the second user account and a central distribution server account.

2. The method of claim 1, further comprising the step of:
following display of the targeted media on at least one of the first user device and the second user device, retrieving a targeted media response from at least one of the first user and the second user.

3. The method of claim 1, wherein the targeted media response triggers an additional transaction.

4. The method of claim 1, wherein the targeted media response triggers a delay in displaying the advertisement.

5. The method of claim 1, wherein the advertisement response discards the advertisement and at least one of the first user account and the second user account is updated accordingly.

6. The method of claim 1, wherein the targeted media is automatically selected based on at least one pre-established factor selected from the group of: first user identity, second user identity, transaction type, geographic location and advertisement display frequency.

7. The method of claim 1, wherein after the targeted media has been displayed, further comprising the step of displaying an additional call-to-action on at least one of the first user device and the second user device.

8. A system for executing an electronic commercial transaction, the system comprising:
at least a first user device having electronic access to a first user account and in electronic communication with an electronic communication network;
at least a second user device having electronic access to a second user account and in electronic communication with an electronic communication network; and
a central distribution server having electronic access to a central distribution server account and in electronic communication with an electronic communication network;
wherein the first user is authenticated electronically with the central distribution server and transaction information is received from the first user device over the electronic communication network;
transaction information is sent electronically from the first user device to the second user device over the electronic communication network;
the second user device is authenticated electronically with the central distribution server and transaction confirmation information is received from the second user device by the central distribution server;
a query is sent from the central distribution server to at least one of the first user device and the second user device, and
a query response is retrieved from at least one of the first user device and the second user device and sent to the central distribution server;
if the query response indicates that targeted media will not be displayed:
transaction execution information is retrieved from at least one of the first user device and the second user device; and
funds are electronically transferred from one of the first user account and the second user account to at least one of the other of the first user account and the second user account and the central distribution server account; and
if the query response indicates that targeted media will be displayed:
targeted media is retrieved from the central distribution server;
the targeted media is sent to at least one of the first user device and the second user device;
the targeted media is displayed on at least one of the first user device and the second user device;
transaction execution information is retrieved from at least one of the first user device and the second user device; and
funds are electronically transferred from one of the first user account and the second user account to at least one of the other of the first user account and the second user account and the central distribution server account.
